(19) United States
(12) Patent Application Publication
(10) Pub. No.: US 2012/0330493 A1
(43) Pub. Date: Dec. 27, 2012

(54) METHOD AND APPARATUS FOR DETERMINING ROAD SURFACE CONDITION

(75) Inventors: Yasushi HANATSUKA, Kodaira-shi (JP); Tomoyuki HIGUCHI, Minato-ku (JP); Tomoko MATSUI, Minato-ku (JP)

(73) Assignees: Inter-University Research Institute Corporation, Research Organization of Information and System, Tokyo (JP); KABUSHIKI KAISHA BRIDGESTONE, Tokyo (JP)

(21) Appl. No.: 13/527,917

(22) Filed: Jun. 20, 2012

(30) Foreign Application Priority Data
Jun. 24, 2011 (JP) 2011-140943

(51) Int. Cl. G06F 17/16

(52) U.S. Cl. 701/29.1

(57) ABSTRACT

A method, featuring robustness against changes in tire size, is provided for determining a road surface condition by dividing a time-series waveform of tire vibrations into windows without resorting to detection of the peak positions or measurement of the wheel speed. A time-series waveform of tire vibrations detected by a tire vibration detecting unit is windowed by a windowing unit. Time-series waveforms are extracted from the respective time windows, feature vectors X are calculated therefor, and then likelihoods Z for road-surface HMMs (hidden Markov models) are calculated. The likelihoods Z1 to Z5 calculated for the respective road-surface HMMs are compared with one another, and a road surface condition corresponding to the road-surface HMM showing the highest likelihood is determined to be the condition of the road surface on which the tire is running.

### CROSS-REFERENCES TO RELATED APPLICATIONS

The present application is based on Japanese Priority Application No. 2011-140943 filed on Jun. 24, 2011 with the Japanese Patent Office, the entire contents of which are hereby incorporated by reference.

### BACKGROUND OF THE INVENTION

1. Field of the Invention

The present invention relates to a method and an apparatus for determining the condition of a road surface on which a vehicle is running, and more particularly to a method for determining a road surface condition using only the data of a time-series waveform of the vibrations of a moving tire.

2. Description of the Related Art

There have been proposed methods for estimating a road surface condition by detecting the vibrations of a moving tire, such as one disclosed in WO 2006/135090 A1. In such a method, a time-series waveform of detected tire vibrations is divided into a plurality of regions, such as “pre-leading-edge region, contact patch region, post-trailing-edge region” or “pre-leading-edge region, leading-edge region, contact patch region, trailing-edge region, post-trailing-edge region”. And the vibration level in a frequency band where the frequency level changes markedly with the changing road surface condition and the vibration level in a frequency band where it does not change much with the road surface condition, such as seen in the vibration component in a low-frequency band and the vibration component in a high-frequency band in the pre-leading-edge region and the contact patch region, are extracted from each of the regions. Then the condition of the road surface on which the vehicle is running is estimated from the ratio between these vibration levels.

In the conventional method as described above, however, it has been necessary to set a starting point of a specific time position based on a peak position, such as the trailing edge (tire disengagement) position appearing in a time-series waveform of tire vibrations and determine the time widths of respective regions using the wheel speed. As a result, the accuracy in setting the region widths has not been necessarily adequate.

Also, with tires of different sizes, it has been necessary to change the setting of the region widths for each tire size since such tires can vary in contact patch length from one to another.

The present invention has been made to solve the above-described problems, and an object thereof is to provide a method and apparatus for determining a road surface condition by dividing a time-series waveform of tire vibrations without detection of peak positions or measurement of wheel speed, thereby adding robustness against changes in tire size in the determination of road surface condition.

### SUMMARY OF THE INVENTION

The present invention provides a method for determining a road surface condition, which includes the steps of detecting vibrations of a moving tire, extracting time-series waveforms of tire vibrations in predetermined time widths from the tire vibrations detected, calculating feature vectors from the time-series waveforms, calculating likelihoods of the feature vectors respectively for a plurality of hidden Markov models (HMMS) structured to represent predetermined road surface conditions, and comparing the likelihoods calculated respectively for the plurality of hidden Markov models with one another and determining a road surface condition corresponding to the hidden Markov model showing the highest likelihood to be the condition of the road surface on which the tire is running, in which each of the feature vectors is vibration levels in specific frequency bands or a function of the vibration levels and in which each of the hidden Markov models has at least four different states.

Note that the “four different states” mentioned above are the two states of “initial” and “final” states plus two states out of the five states of “pre-leading-edge”, “leading-edge”, “pre-trailing-edge”, “trailing-edge”, and “post-trailing-edge” states.

As mentioned above, the hidden Markov models (hereinafter referred to as HMMs) are applied to the time-series waveform of tire vibrations. Therefore, the waveform of tire vibrations can be divided into a plurality of characteristic states without resorting to detection of the peak positions or measurement of the wheel speed. And a road surface condition is determined based on the likelihoods calculated using the output probability and the state transition probability of the feature vectors in the respective states. Hence, the accuracy in determining a road surface condition can be improved markedly.

Also, the application of the HMMs allows the determination of a road surface condition irrespective of the contact patch length. This feature adds robustness against changes in tire size to the present method for determining a road surface condition.

Also, the present invention provides an apparatus for determining a road surface condition, which includes a tire vibration detecting unit disposed on the air chamber side of an inner liner portion of a tire tread for detecting vibrations of a moving tire, a windowing unit for windowing the time-series waveform of tire vibrations detected by the tire vibration detecting unit in predetermined time widths and extracting time-series waveforms of tire vibrations from the respective time windows, a feature vector calculating unit for calculating feature vectors, each having as components vibration levels in specific frequency bands or a function of the vibration levels, for the time-series waveforms extracted from the respective time windows, a storage unit for storing a plurality of hidden Markov models, each having at least four states, structured in advance for different road surface conditions, a likelihood calculating unit for calculating the likelihoods of the feature vectors for the plurality of hidden Markov models stored in the storage unit, and a determining unit for comparing the likelihoods calculated respectively for the plurality of hidden Markov models with one another and determining a road surface condition corresponding to the hidden Markov model showing the highest likelihood to be the condition of the road surface on which the tire is running.

An apparatus for determining a road surface condition having a structure as mentioned above can reliably implement the method for determining a road surface condition as described in the first aspect. Therefore, the apparatus can accurately set the time widths of the pre-leading-edge region and the post-trailing-edge region without detection of the peak positions or measurement of the wheel speed, thus improving the accuracy in determining a road surface condition.

It is to be understood that the foregoing summary of the invention does not necessarily recite all the features essential to the invention, and subcombinations of all these features are intended to be included in the invention.

### BRIEF DESCRIPTION OF THE DRAWINGS

FIG. 1 is a functional block diagram showing a structure of a road surface condition determining apparatus in accordance with the present invention.

FIG. 2 is an illustration showing an example of the location of an acceleration sensor.

FIG. 3 is a diagram showing a time-series waveform of tire vibrations in the pre-leading-edge region, leading-edge region, pre-trailing-edge region, trailing-edge region, and post-trailing-edge region.

FIG. 4 is a diagram showing an example of a road-surface HMM.

FIG. 5 is a diagram showing road-surface HMMs used in calculating likelihoods.

FIG. 6 is a schematic representation of state transition series.

FIG. 7 is a flowchart showing a method for determining a road surface condition in accordance with the present invention.

FIG. 8 is a diagram showing examples of road-surface HMMs and an extra-road-surface HMM.

FIG. 9 is a diagram showing examples of combinations of intra-road-surface HMMs and extra-road-surface HMMs.

FIG. 10 is a diagram showing other examples of combinations of intra-road-surface HMMs and an extra-road-surface HMM.

FIG. 11 is a diagram showing other examples of combinations of intra-road-surface HMMs and an extra-road-surface HMM.

FIG. 12 is a table showing the results of determination of road surface conditions using road-surface HMMs.

### DESCRIPTION OF THE PREFERRED EMBODIMENTS

The invention will now be described based on preferred embodiments which do not intend to limit the scope of the claims of the present invention but exemplify the invention. All of the features and the combinations thereof described in the embodiments are not necessarily essential to the invention.

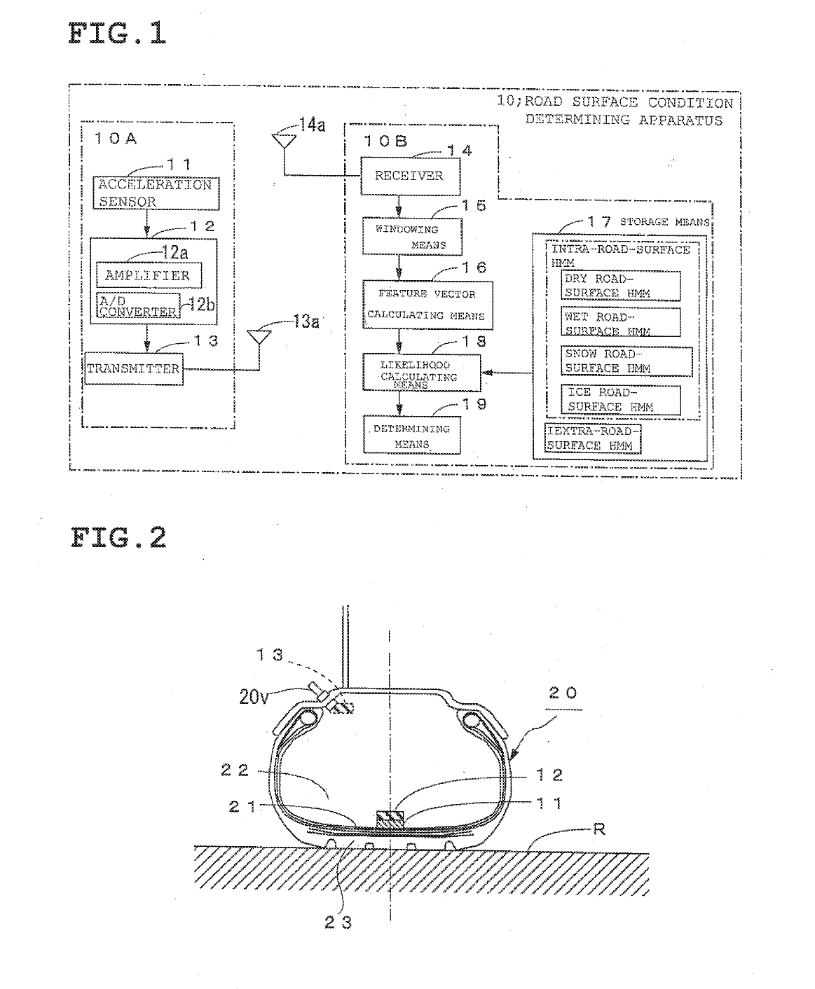

FIG. 1 is a functional block diagram showing a structure of a road surface condition determining apparatus 10. The road surface condition determining apparatus 10 comprises a sensor section 10A and an arithmetic processing section 10B.

The sensor section 10A includes an acceleration sensor 11, a signal input-output unit 12, and a transmitter 13.

The acceleration sensor 11 is disposed integrally in a substantially middle portion on the tire air chamber 22 side of the inner liner portion 21 of a tire 20, as illustrated in FIG. 2, and detects the vibrations of the tire 20 inputted from a road surface R. The tread of the tire 20 is denoted by reference numeral 23.

The signal input-output unit 12 includes an amplifier 12a that amplifies the output of the acceleration sensor 11 and an A/D converter 12b that converts an amplified signal into a digital signal. The signal input-output unit 12 is disposed integrally with the acceleration sensor 11.

The transmitter 13, which is disposed near a valve 20v of the tire 20, is provided with an antenna 13a for transmitting the A/D-converted data of tire vibrations to the arithmetic processing section 10B installed on the vehicle body.

The arithmetic processing section 10B includes a receiver 14, a windowing unit 15, a feature vector calculating unit 16, a storage unit 17, a likelihood calculating unit 18, and a determining unit 19.

The receiver 14, which is provided with an antenna 14a, receives with the antenna 14a a time-series waveform, which is the data of tire vibrations sent from the transmitter 13, and sends it to the windowing unit 15.

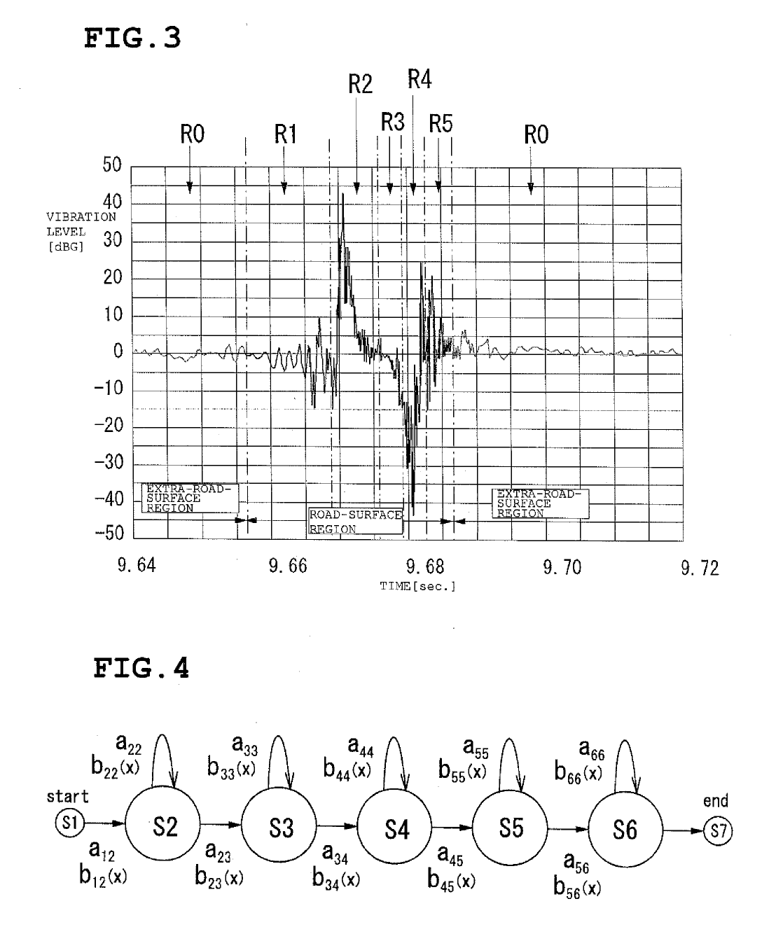

FIG. 3 is a diagram showing an example of a time-series waveform of tire vibrations. A time-series waveform of tire vibrations has marked peaks in the vicinities of the leading edge and the trailing edge of the contact patch of the tire. Also, in actuality, vibrations differing with the road surface condition appear in the region preceding the leading edge (pre-leading-edge region R₁) and the region following the trailing edge (post-trailing-edge region R₅) when the land portions of the tire 20 are not in contact with the road surface. Hereinbelow, the region from pre-leading-edge region R₁ to post-trailing-edge region R₅ will be referred to as the road-surface region, and the regions other than the road surface region as the extra-road-surface region. The road surface region consists of the pre-leading-edge region R₁, the leading-edge region R₂, the pre-trailing-edge region R₃, the trailing-edge region R₄, and the post-trailing-edge region R₅.

The extra-road-surface region is little affected by the road surface condition. That is, the extra-road-surface region has low vibration levels and contains little information on the road surface. This region is therefore called the non-informative region R₀ also.

The non-informative region maybe set, for instance, as the region with lower vibration levels than a background level which is predetermined in relation to the time-series waveform of tire vibrations.

The windowing unit 15 windows the above-described time-series waveform in predetermined time widths (time window widths), extracts time-series waveforms of tire vibrations from the respective time windows, and sends the data to the feature vector calculating unit 16.

The feature vector calculating unit 16 calculates feature vectors X for the respective time-series waveforms extracted from the time windows. In this embodiment, used as the feature vectors X are the vibration levels in specific frequency bands (power values of filtered waves) xₖ(t), which are each obtained by passing the time-series waveform of tire vibrations through the bandpass filters 161 to 166 of 0-0.5 kHz, 0.5-1 kHz, 1-2 kHz, 2-3 kHz, 3-4 kHz, and 4-5 kHz. These feature vectors X are therefore 6-dimensional.

The storage unit 17 stores a plurality of hidden Markov models structured respectively for different road surface conditions (hereinafter referred to as road-surface HMMs). The road-surface HMMs include intra-road-surface HMMs (road) and extra-road-surface HMMs (silent). The intra-road-surface HMMs (road) are structured form a vibration waveform appearing in the road surface region of the time-series waveform of tire vibrations, whereas the extra-road-surface HMMs (silent) are structured from a vibration waveform appearing in the non-informative region.

As shown in FIG. 4, the road-surface HMMs have each seven states S₁ to S₇ corresponding to the time-series waveform of tire vibrations. And the states S₁ to S₇ are each comprised of two kinds of parameters, namely, the output probability bᵢⱼ(X) of the feature vector X and the transition probability aᵢⱼ(X) between the states (i, j=1 to 7).

In the present embodiment, a learning process is carried out for dividing the time-series waveform of tire vibrations into five states, namely, the five states S₂ to S₆ excepting the initial state S₁ and the final state S₇ of each road-surface HMM, and thereby the output probabilities bᵢⱼ(X) of the feature vectors X and the transition probabilities aᵢⱼ(X) between the states of each road-surface HMM are obtained.

The output probabilities bᵢⱼ(X) are each the probability of the feature vector X being outputted when the state transits from state Sᵢ to state Sⱼ. The output probabilities bᵢⱼ(X) are each assumed to have a contaminated normal distribution.

The transition probabilities aᵢⱼ(X) are each the probability of the state transiting from state Sᵢ to state Sⱼ.

It should be noted that when the feature vectors X are k-dimensional, the output probabilities bᵢⱼ are set respectively for k components xₖ of the feature vectors X.

In the present embodiment, the data of the time-series waveforms of tire vibrations which have been obtained by operating vehicles fitted with a tire 20 equipped with an acceleration sensor 11 on each of the dry, wet, snowy, and icy road surfaces were used as the data to be learned. And five road-surface HMMs, which are four intra-road-surface HMMs (road) of DRY road-surface HMM, WET road-surface HMM, SNOW road-surface HMM, and ICE road-surface HMM and an extra-road-surface HMM (silent), have been structured.

The intra-road-surface HMMs (road) and the extra-road-surface HMM (silent) are each an HMM having the seven states S₁ to S₇ including the initial state S₁ and the final state S₇.

The learning for the HMMs is done using a known technique such as EM algorithm, Baum-Welch algorithm, or forward-backward algorithm.

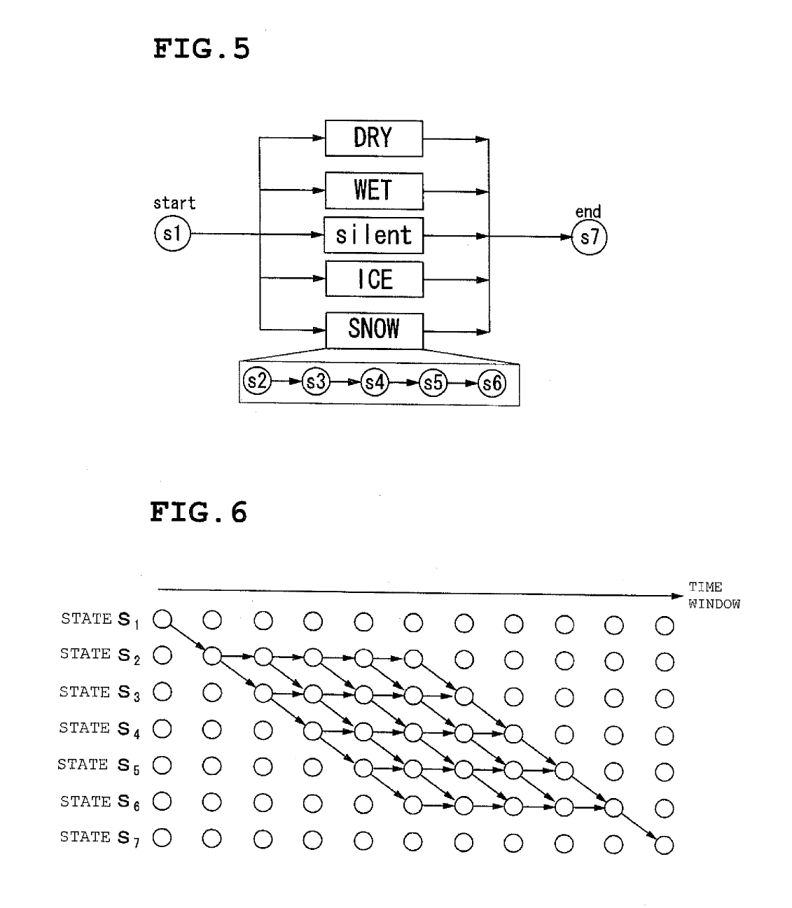

The likelihood calculating unit 18 calculates the likelihoods of the feature vector X for each of a plurality (five here) of road-surface HMMs as shown in FIG. 5.

To obtain the likelihoods of the feature vectors X, the output probability P(Xₜ) in each time window is first calculated, using the following equation:

$$P ( {X}_{t} ) = {\prod }_{s = 1}^{S} [ {\sum }_{m = 1}^{Ms} {c}_{jsm} N ( {X}_{st} \vert {μ}_{jsm} , {σ}_{jsm} ) ]$$

$$N ( X \vert μ , σ ) = \frac{1}{\sqrt{{( 2 π )}^{n} \vert σ \vert}} exp \{ - \frac{1}{2} ( X - μ ) {{σ}^{- 1} ( X - μ )}^{T} \}$$

where

X: data series

t: time

S: number of states

Mₛ: number of components of mixture gaussian distribution

Cⱼₛₘ: mixing ratio of mth mixture component

μ: mean vector of gaussian distribution

σ: variance-covariance matrix of gaussian distribution

The transition probability π(Xₜ) can be represented by a 7×7 matrix since a road-surface HMM has seven states. As this transition probability π(Xₜ), the transition probabilities aᵢⱼ(X) between the states of the feature vectors X obtained through the learning for the road-surface HMMs may be used.

Then the occurrence probability K(Xₜ) in each time window, which is the product of the output probability P(Xₜ) calculated as above and the transition probability π(Xₜ), is calculated, and the likelihood Z is obtained by multiplying the occurrence probabilities K(Xₜ) in all time windows together. That is, the likelihood Z can be calculated as Π P(Xₜ) times the transition probability π(Xₜ). Or the likelihood Z may also be found by adding together the logarithms of the occurrence probabilities K(Xₜ) calculated for all the time windows.

It should be noted that there are a plurality of routes for transition of a road-surface HMM from state S₁ to state S₇ (state transition series) as shown in FIG. 6. In other words, the likelihood Z varies with the state transition series for each of the road-surface HMMs.

In this embodiment, a state transition series Z_{M}, which has the highest likelihood Z, is derived using the well-known Viterbi algorithm. And this state transition series is determined to be the state transition series corresponding to the time-series waveform of detected tire vibrations, and the above likelihood Z_{M} is chosen to be the Z of the applicable road-surface HMM.

The likelihood Z_{M} is thus found for each of the road surface HMMs.

The determining unit 19 compares the likelihoods of the plurality of hidden Markov models calculated by the likelihood calculating unit 18 with one another and determines the road surface condition corresponding to the hidden Markov model showing the highest likelihood to be the condition of the road surface on which the tire is running.

That is, if the likelihood of the DRY road-surface HMM is denoted by Z1, that of the WET road-surface HMM by Z2, that of the SNOW road-surface HMM by Z3, that of the ICE road-surface HMM by Z4, and that of the extra-road-surface HMM by Z5, then the determining unit 19 compares Z1 to Z5 with one another and determines the road surface condition corresponding to the road-surface HMM showing the highest likelihood to be the current condition of the road surface. Note that when the likelihood Z5 is the highest, the data is determined to be the data applicable outside the road surface, so that no determination of the road surface condition is performed.

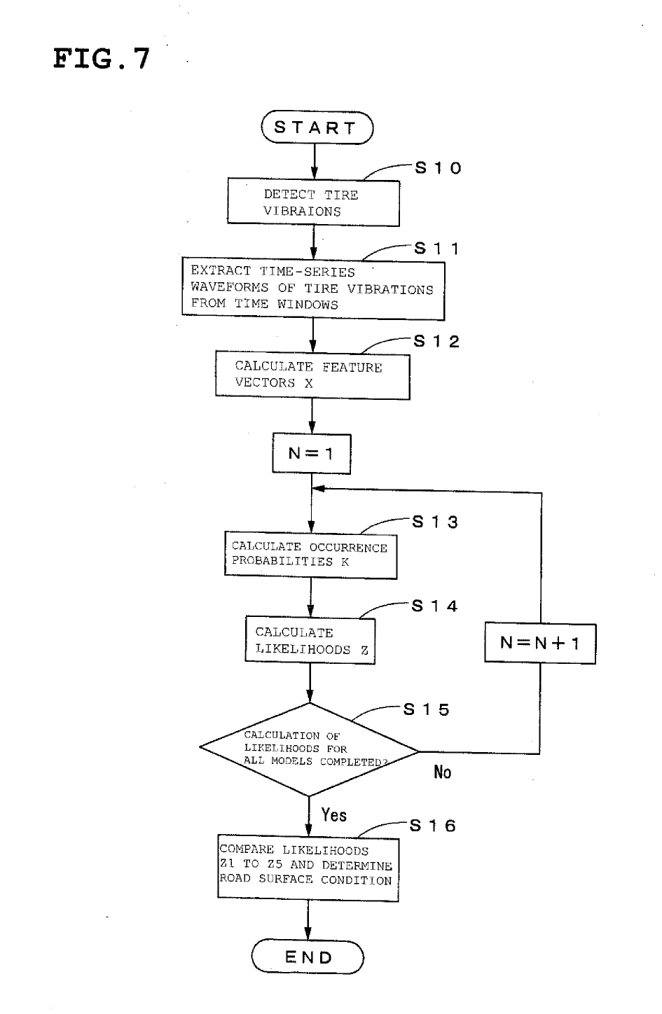

Now, with reference to the flowchart of FIG. 7, a description will be given of a method for determining the condition of a road surface on which a tire 20 is running, using a road surface condition determining apparatus 10. In the present embodiment, five models of DRY road-surface HMM, WET road-surface HMM, SNOW road-surface HMM, and ICE road-surface HMM as intra-road-surface HMMs and an extra-road-surface HMM are used.

First tire vibrations as inputted from a road surface R on which the tire 20 is running are detected by an acceleration sensor 11, and the data is sent to an arithmetic processing section 10B (S10).

Then the time-series waveform, which is the data on the tire vibrations, is windowed into predetermined time windows, and time-series waveforms of tire vibrations are extracted from the respective time windows (S11). After that, a feature vector X=(x₁(t), x₂(t), x₃(t), x₄(t), x₅(t), x₆(t)) is calculated for each of the time-series waveforms extracted from the respective time windows (S12).

In the present embodiment, the time window width is 2 msec.

As noted above, each of the components x₁(t) to x₆(t) of the feature vector X is the power value of filtered waves of the time-series waveform of tire vibrations.

After the calculation of the feature vectors X, the likelihoods of the feature vectors X for the plurality of the road-surface HMMs are calculated (S13 to S15) as shown in FIG. 5. The structure of each road-surface HMM is as shown in FIG. 4.

More specifically, the occurrence probability K(Xₜ) in each time window, which is “output probability P(Xₜ)×transition probability π(Xₜ)”, is first calculated for the DRY road-surface HMM, which is the first model (S13). And the likelihood Z1 for the DRY road-surface HMM is obtained by multiplying the occurrence probabilities K(Xₜ) of all the time windows together (S14).

Next, a determination is made as to whether the calculation of the likelihoods Z has been completed for all the models or not (S15). If the calculation is not completed, the procedure will go back to step 13, where the likelihood Z2 for the WET road-surface HMM, which is the next model, is calculated.

When the calculation of the likelihoods Z for all the five models has been completed, the procedure will advance to step 16, where the likelihoods Z1 to Z5 calculated for the respective road-surface HMMs are compared with one another, by which the road surface condition corresponding to the road-surface HMM showing the highest likelihood is determined to be the condition of the road surface on which the tire is now running.

As described above, in the present embodiment, a time-series waveform of tire vibrations detected by an acceleration sensor 11 is windowed by a windowing unit 15. Time-series waveforms of tire vibrations are extracted from the respective time windows, feature vectors X are calculated therefor, and then the likelihoods Z for the respective road-surface models are calculated. Now the likelihoods Z1 to Z5 calculated for the respective road-surface HMMs are compared with one another, and the road surface condition corresponding to the road-surface HMM showing the highest likelihood is determined to be the condition of the road surface on which the tire is running. Therefore, the road surface condition can be determined without resorting to detection of the peak positions or measurement of the wheel speed.

Also, the method described features robustness against changes in tire size because the road surface condition can be determined irrespective of the contact patch length of a tire.

In the embodiment disclosed above, an acceleration sensor 11 is employed as the tire vibration detecting means, but other means of vibration detection, such as a pressure sensor, may be used as the tire vibration detecting means. Also, the acceleration sensor 11 may be located in other positions. For example, a pair of acceleration sensors 11 may be disposed at positions a predetermined distance axially apart from the tire width center, or the acceleration sensor 11 may be installed within a block. Also, the number of acceleration sensors 11 is not limited to one, but a plurality of acceleration sensors 11 may be disposed at a plurality of circumferential positions of a tire.

Also, in the foregoing embodiment, the power values xₖ(t) of filtered waves are used for the feature vector X, but the mean value μₖ and standard deviation σₖ of the time-varying dispersion of the power values xₖ(t) of filtered waves may be used instead. The time-varying dispersion can be expressed as log[xₖ²(t)+xₖ₋₁²(t)]. In this case, the dimensions of the feature vector x are: “number of frequency bands (6)×number of parameters (2)=12”.

Also, the Fourier coefficients, which are the vibration levels in specific frequency bands when a Fourier transform is performed on the time-series waveform of tire vibrations, or the cepstral coefficients thereof maybe used for the feature vector X.

In the case of the cepstral coefficients, the waveform after the Fourier transform is assumed to be a spectral waveform, and a Fourier transform is again performed thereon to obtain them. Or the AR spectrum is assumed to be a waveform, and an AR coefficient is further derived to obtain them (LPCepstra). Thus, the shape of the spectrum can be characterized without being affected by the absolute levels, so that the use of the cepstral coefficients enhances the accuracy of determination higher than when the frequency spectrum obtained by a Fourier transform is used. In the case of LPCepstra, the feature vector X has 39 dimensions because “power value (1)+cepstral coefficient (12)” and their primary differences and secondary differences are used.

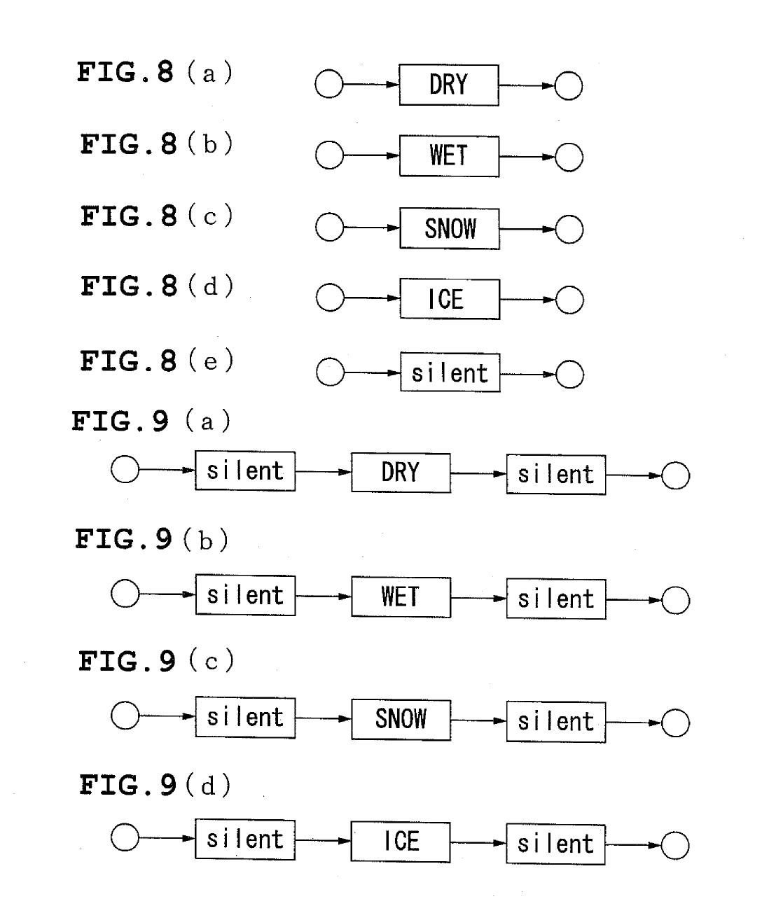

Also, in the foregoing embodiment, five road-surface HMMs (four intra-road-surface HMMs (road) and one extra-road-surface HMM (silent)), each having seven states (S₁ to S₇), are set as shown in FIGS. 8A to 8E. However, combinations of intra-road-surface HMM (road) and extra-road-surface HMM (silent) may be used also.

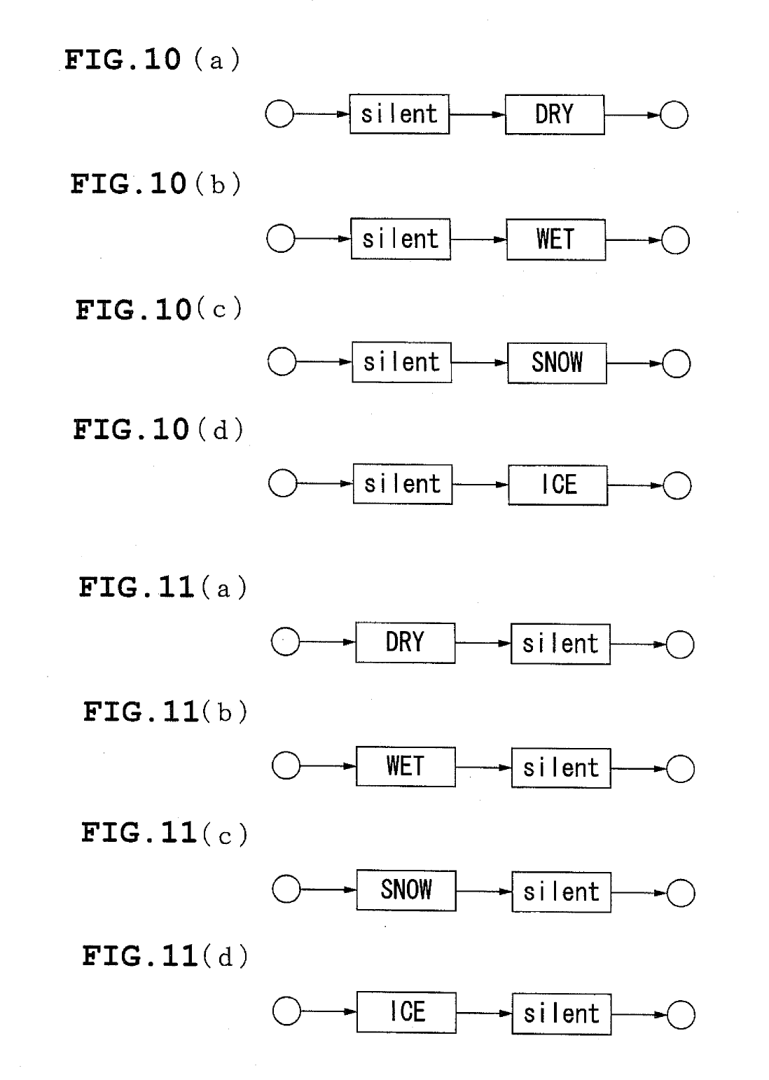

Such combinations may include not only silent-road-silent combinations as shown in FIGS. 9A to 9D, but also silent-road combinations as shown in FIGS. 10A to 10D and road-silent combinations as shown in FIGS. 11A to 11D.

There are four kinds of intra-road-surface HMMs (road), namely, the DRY road-surface HMM, WET road-surface HMM, SNOW road-surface HMM, and ICE road-surface HMM. With the sole extra-road-surface HMM (silent) shown in FIG. 8E added, there will be a total of 14 road-surface HMMs. Therefore, the accuracy of determination of a road surface condition will be further enhanced if a plurality or all of the 12 models shown in FIGS. 9 to 11 are added to the five models shown in FIGS. 8A to 8E.

### EXAMPLE

Four test vehicles A to D each fitted with a tire which had an acceleration sensor installed thereon were operated at speeds of 30 to 90 km/h on each of dry, wet, snowy, and icy roads. The time-series waveforms of tire vibrations were thus obtained, and the road surface conditions were determined, using the road-surface HMMs.

The test vehicle A was a front-wheel-drive vehicle whose tire size was 165/70R14.

The test vehicle B was a rear-wheel-drive vehicle whose tire size was 195/65R15.

The test vehicle C was a front-wheel-drive vehicle whose tire size was 195/60R15.

The test vehicle D was a front-wheel-drive vehicle whose tire size was 185/70R14.

Note that the tread pattern on all the tires used in the test was Bridgestone's BLIZZAK REV02.

The data used in the learning process was the data used with the test vehicle A.

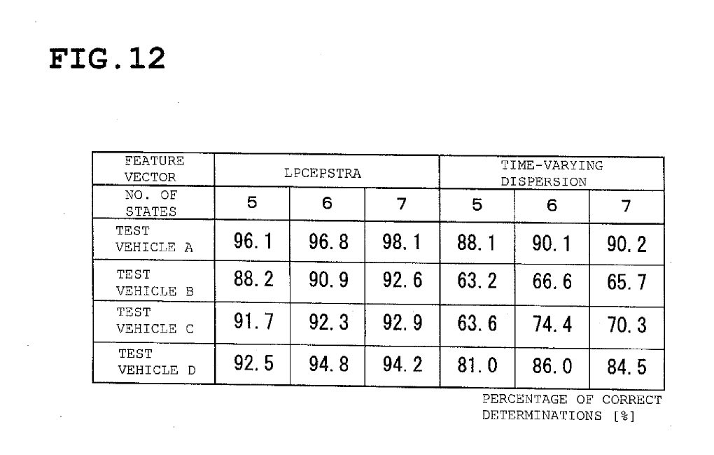

And the road surface conditions were determined, using 17 models as shown in FIGS. 8 to 11 as the road-surface HMMs. And the tests were made for two cases of the LPCepstra and the mean value μₖ and standard deviation σₖ of the time-varying dispersion of the power value xₖ(t) of filtered waves used for the feature vector X. The results are shown in the table of FIG. 12. The results of determination are represented by the percentage of correct determinations.

As is evident from the table of FIG. 12, when the LPCepstra was used, the percentage of correct determinations was about 90% or higher with all the test tires. Also, when the mean value μₖ and standard deviation σₖ of the time-varying dispersion of the power value xₖ(t) of filtered waves were used, the percentage of correct determinations was quite high at about 80% or above with the test vehicles A and D although it was not necessarily adequate with the vehicles B and C which were fitted with tires of large cross-sectional width. Therefore, it has been confirmed that the present invention realizes determination of a road surface condition with excellent accuracy.

In the foregoing specification, the invention has been described with reference to specific embodiments thereof. However, the technical scope of this invention is not to be considered as limited to those embodiments. It will be evident to those skilled in the art that various modifications and changes maybe made thereto without departing from the broader spirit and scope of the invention. It will also be evident from the scope of the appended claims that all such modifications are intended to be included within the technical scope of this invention.

According to the present invention, the time-series waveform of tire vibrations can be divided without resorting to detection of the peak positions or measurement of the wheel speed, and a road surface condition can be determined with robustness of the method against changes in tire size. Therefore, the accuracy of vehicular control, such as antilock braking system (ABS) and vehicle stability control (VSC), can be improved markedly.

1. A method for determining a road surface condition,
comprising the steps of:
detecting vibrations of a moving tire;
extracting time-series waveforms of tire vibrations in predetermined time widths from the tire vibrations detected;
calculating feature vectors from the time-series waveforms;
calculating likelihoods of the feature vectors respectively for a plurality of hidden Markov models (HMMS) structured to represent predetermined road surface conditions; and
comparing the likelihoods calculated respectively for the plurality of hidden Markov models with one another and determining a road surface condition corresponding to the hidden Markov model showing the highest likelihood to be the condition of the road surface on which the tire is running,
wherein each of the feature vectors is vibration levels in specific frequency bands or a function of the vibration levels and wherein each of the hidden Markov models has at least four different states.

2. The method for determining a road surface condition according to claim 1, wherein the feature vector is one, two or more, or all of:
vibration levels in specific frequency bands when a Fourier transform is performed on the time-series waveform,
vibration levels in specific frequency bands obtained by passing the time-series waveform through bandpass filters,
time-varying dispersions of the vibration levels in specific frequency bands, and
frequency cepstral coefficients of the time-series waveform.

3. The method for determining a road surface condition according to claim 1, wherein each of the hidden Markov models for the respective road surface conditions has seven states.

4. The method for determining a road surface condition according to claim 1, wherein the hidden Markov models for the respective road surface conditions include an extra-road-surface hidden Markov model, structured from a vibration waveform which is a vibration waveform other than that of the contact patch and whose vibration level is lower than a predetermined background level, and intra-road-surface hidden Markov models, structured from vibration waveforms which are vibration waveforms of the contact patch or those before and after the contact patch and whose vibration level is equal to or higher than the predetermined background level, and wherein the extra-road-surface hidden Markov model is provided either before or after or both before and after the intra-road-surface hidden Markov models.

5. An apparatus for determining a road surface condition,
comprising:
a tire vibration detecting unit disposed on the air chamber side of an inner liner portion of a tire tread for detecting vibrations of a moving tire;
a windowing unit for windowing a time-series waveform of tire vibrations detected by the tire vibration detecting unit in predetermined time widths and extracting time-series waveforms of tire vibrations from the respective time windows;
a feature vector calculating unit for calculating feature vectors, each having as components vibration levels in specific frequency bands or a function of the vibration levels, for the time-series waveforms extracted from the respective time windows;
a storage unit for storing a plurality of hidden Markov models, each having at least four states, structured in advance for different road surface conditions;
a likelihood calculating unit for calculating the likelihoods of the feature vectors for the plurality of hidden Markov models stored in the storage unit; and
a determining unit for comparing the likelihoods calculated respectively for the plurality of hidden Markov models with one another and determining a road surface condition corresponding to the hidden Markov model showing the highest likelihood to be the condition of the road surface on which the tire is running.
